(19) United States
(12) Patent Application Publication
(10) Pub. No.: US 2003/0018662 A1
(43) Pub. Date: Jan. 23, 2003

(54) Synchronizing multimedia data

(76) Inventor: Sheng Li, San Diego, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/909,543

(22) Filed: Jul. 19, 2001

(51) Int. Cl. G06F 15/00

(52) U.S. Cl. 707/500.1

(57) ABSTRACT

Synchronization of multimedia data having at least audio and text sequences is disclosed. The audio sequence is divided into at least one audio data group, where a current audio data group is synchronized to a nearest time mark. The current audio data group is then associated to a number of a word in the text sequence corresponding to the current audio data group.

### BACKGROUND

The present invention relates to synchronization of multimedia data, and more particularly, to synchronizing multimedia data without using timestamps.

Multimedia systems deal with various types of multimedia data such as video, audio, text, graphical image, and other related data. In order to represent, in such systems, a plurality of multimedia data objects simultaneously in a single network transfer packet, all those objects should follow to the transition of time, location, or frame numbers, being synchronized with each other. While video and audio are time-based objects that change as time elapses, text display depends on the frame number. Thus, concurrent presentation of a plurality of those multimedia data may require synchronized output of the data having such different natures.

FIG. 1, for example, illustrates a typical timeline 100 of a multimedia system involving synchronization of text data 104 with audio data 102. In one embodiment, this system may be referred to as closed captioning. In this system, a stream of audio data 102 may be synchronized with text data 104 by providing a timestamp 106 for each word in the text data 104. For example, the first word “Yes” in the text data 104 is time tagged with a timestamp “8”. The second word “it” is time tagged with a timestamp “14”, and so on. In some systems, a timestamp 106 may only be provided for each sentence.

Accordingly, in a typical multimedia system, a transmitter encodes the text content 104 and the timestamp 106 along with the stream of audio data 102. The encoded multimedia data may then be packetized and sent over a network. The receiver decodes the packets, and synchronizes the text display with the stream of audio data 104. However, time tagging each word or sentence in the text data 104 may significantly increase the amount of data to be transmitted. Furthermore, increased amount of data decreases bandwidth available for data stream.

### SUMMARY

In one aspect, synchronizing multimedia data having at least audio and text sequences is disclosed. The audio sequence is divided into at least one audio data group, where a current audio data group is synchronized to a nearest time mark. The current audio data group is then associated to a number of a word in the text sequence corresponding to the current audio data group.

In another aspect, a multimedia system having a processor and a correlator is disclosed. The processor divides audio data into at least one audio data group. The processor is configured to synchronize a current audio data group to a nearest time mark. The correlator then associates the current audio data group to a number of a word in text data corresponding to the current audio data group.

### BRIEF DESCRIPTION OF THE DRAWINGS

FIG. 1 shows a timeline of a conventional multimedia system involving synchronization of text data with audio data.

FIG. 2 shows one example of an audio sequence that is time synchronized according to an embodiment of the present invention.

FIG. 3 illustrates one implementation of multimedia synchronization system according to an embodiment of the present invention.

FIGS. 4A and 4B show one embodiment of encoded packets in the transmitter of the present system.

FIG. 5 is a flowchart of a synchronization process in accordance with an embodiment of the present invention.

FIG. 6 shows one implementation of the multimedia synchronization system in accordance with an embodiment of the present invention.

FIG. 7 shows a multimedia system according to an embodiment of the present invention.

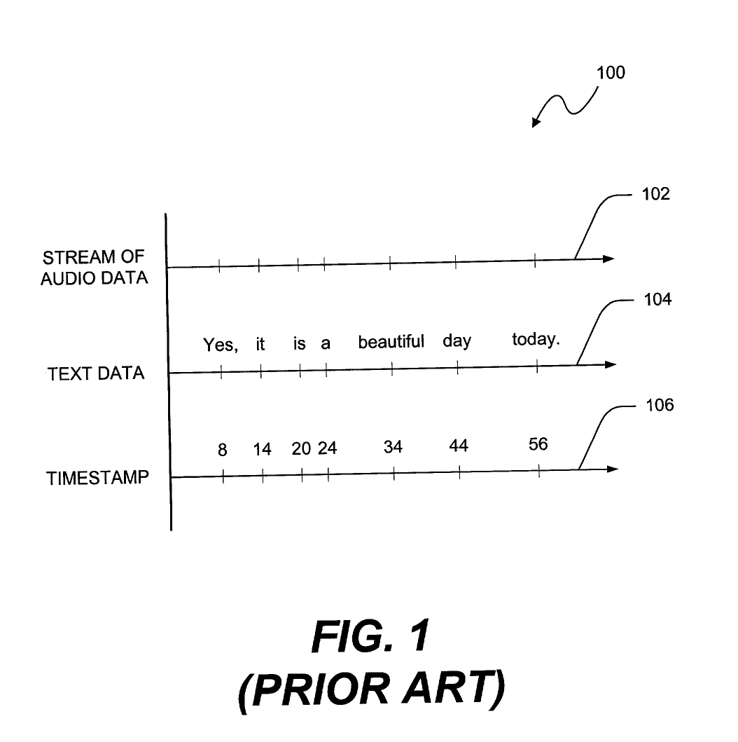

### DETAILED DESCRIPTION

In recognition of the above-described difficulties with prior art design of multimedia systems, the present invention describes embodiments for synchronizing multimedia data without using timestamps. In one embodiment, the present multimedia system includes a slide presentation system having a series of presentation slides. Each slide may be accompanied by an audio sequence and a text sequence. In this embodiment, the presentation system is configured to synchronize words or audio data groups in the audio sequence with words in the text sequence, without using timestamps. The synchronization may be achieved by dividing the audio sequence into audio data groups that are synchronized to time marks in the audio timeline. The words in the text sequence may then be synchronized to the audio data groups by linking the word number with each audio data group. A special word number may be used to indicate that the text should not be advanced when the word audio portion is longer than the audio data group size or when the current audio data group has a sound gap. This special word number may be a number not used to indicate any word in the text sequence (e.g. word number ‘0’). Consequently for purposes of illustration and not for purposes of limitation, the exemplary embodiments of the invention are described in a manner consistent with such use, though clearly the invention is not so limited.

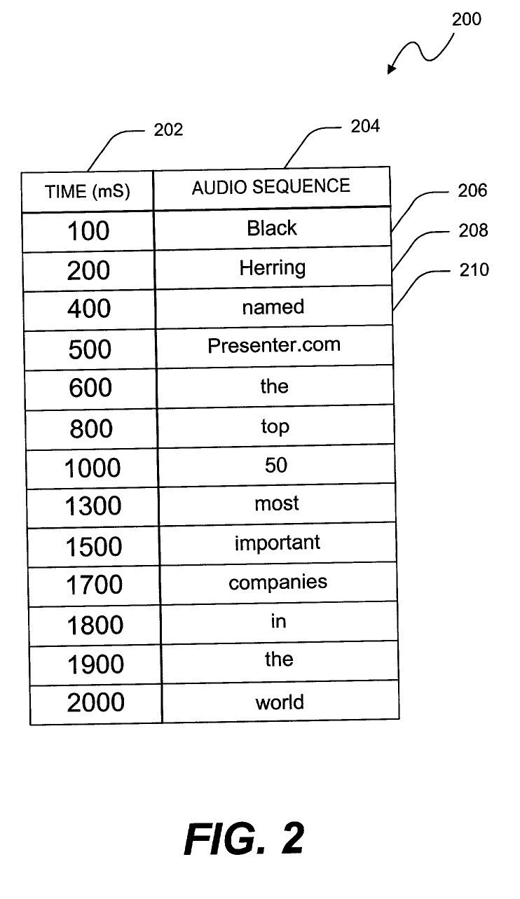

FIG. 2 shows one example of an audio sequence 200 that is time synchronized. In this example, the sentence “Black Herring named Presenter.com the top 50 most important companies in the world.” has been time synchronized according to the times shown in the left column. The time synchronization may be arranged by matching each word or audio data group (ADG) 204 to a nearest time mark 202. The time mark 202 may represent a smallest measuring time unit in an audio sequence. This time mark 202 may be some multiples of an audio frame. The audio frame is typically 20 milliseconds. In the illustrated example of FIG. 2, the time marks 202 are points in the audio sequence timeline that are spaced at a 100-millisecond interval. Thus, the word “Black” is time tagged at 100 milliseconds, which means that the sound “Black” 206 may be heard starting at 100 milliseconds after the beginning of the audio stream. Furthermore, the sound “Herring” 208 may be heard starting at 200 milliseconds after the beginning of the audio stream. Next, the sound “named” 210 may be heard starting at 400 milliseconds after the beginning of the audio stream. This indicates that the duration of the word “Herring” may be as long as 200 milliseconds. Therefore, the synchronization of the audio and text must be adjusted accordingly to account for this change in duration.

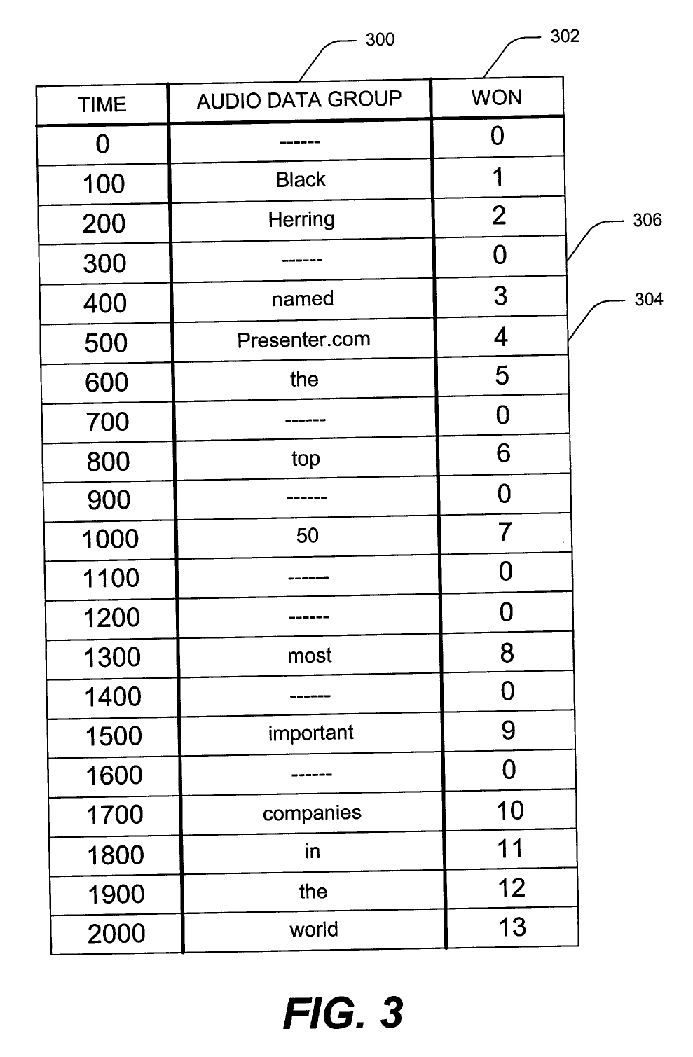

FIG. 3 illustrates one implementation of multimedia synchronization system according to an embodiment of the present invention. In this embodiment, instead of time tagging each word, which may occupy two bytes or more for the timestamp, each audio data group (measuring 100 milliseconds) may be synchronized to a time mark. Moreover, each audio data group (ADG) 300 may be associated with a word ordinal number (WON) 302 as shown. The word ordinal number 302 represents the order of a word within a text sequence. For example, the audio data group “Presenter.com” 304 is a fourth group in the text sequence. Thus, the word ordinal number 302 for “Presenter.com” is 4. Further, in places where the word takes up more than one time mark or the current ADG has a sound gap, the word ordinal number 302 may be represented by an integer 0 (306). This indicates that synchronization update is not needed, and that the text should not be advanced. Since the word ordinal number may be represented with an integer, only 4 bits are needed to synchronize up to 15 words. Only 6 bits are needed to represent as many as 63 words, which may be enough to cover all the words in one slide presentation. In some embodiments, the synchronization may be done at a sentence level instead of the word level.

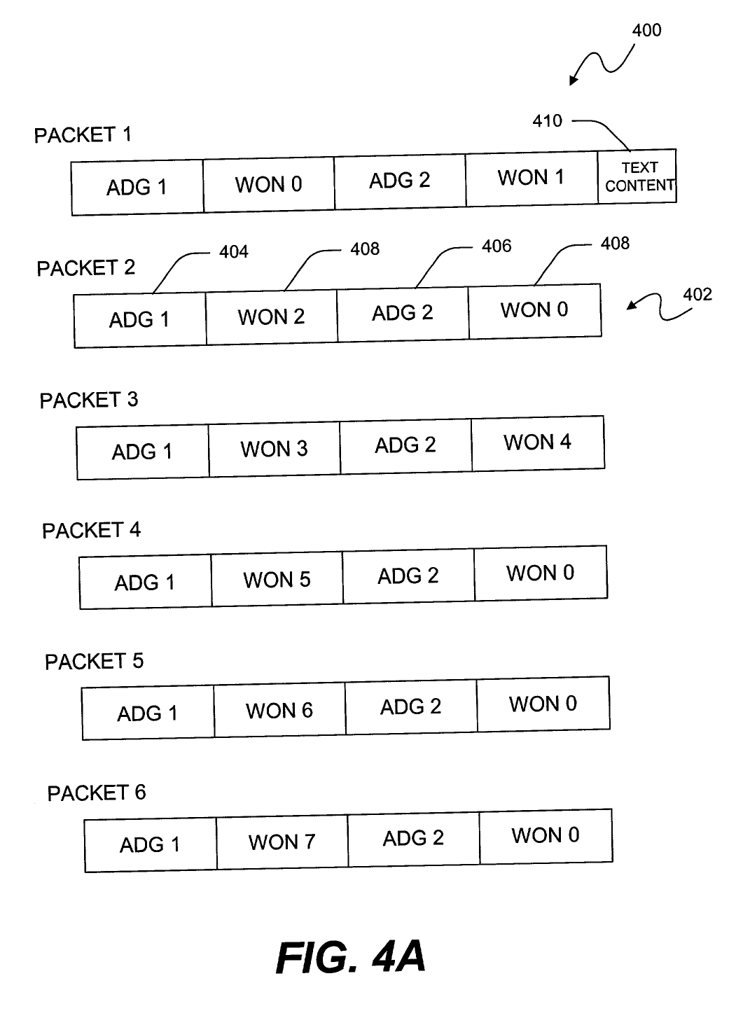

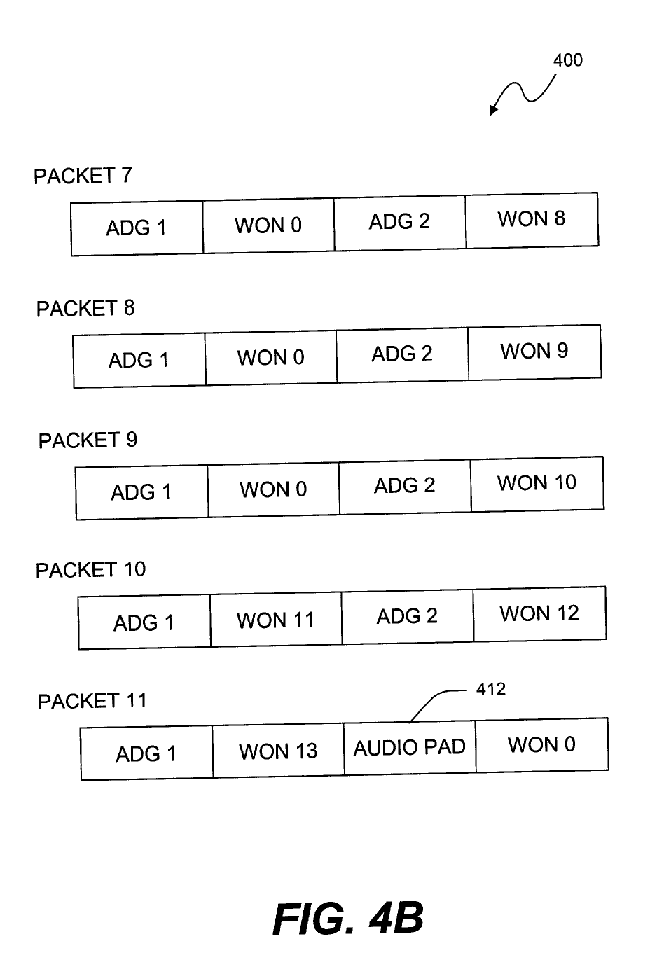

FIGS. 4A and 4B show one embodiment of encoded packets 400 in the transmitter of the present system. The illustrated embodiment of the packets 400 includes all 13 words of the audio sequence example illustrated in FIGS. 2 and 3. In the illustrated embodiment, each packet 402 includes two audio data groups 404, 406 totaling 200 milliseconds of audio data. However, each packet 402 may include more than two groups. Further, each audio data group is associated with a word ordinal number 408 arranged as mentioned above. Thus, the first packet includes ADG1 which is a blank, and ADG2 which corresponds to the text “Black”. The first packet also includes a ‘0’ in the first word ordinal number field (to correspond to a blank audio) and a ‘1’ in the second word ordinal number field (corresponding to the first word “Black”). In some embodiments, the first packet may further include entire text content 410 for a particular presentation or slide. In other embodiments, the last packet may include an audio pad 412 to fill the packet.

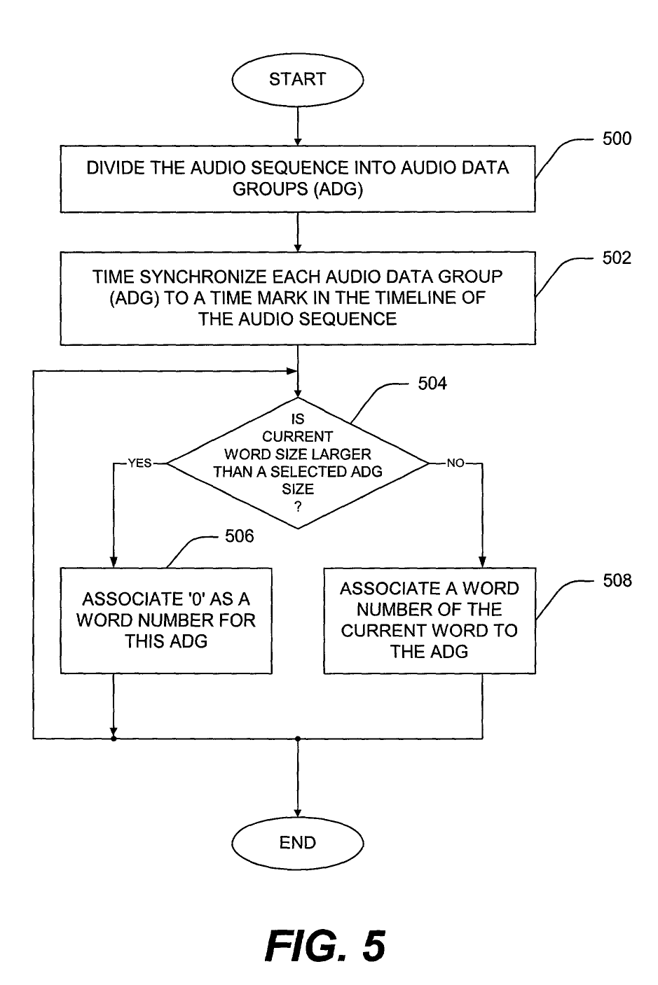

A flowchart of the synchronization process is shown in FIG. 5. The process includes dividing the audio sequence into audio data groups (ADG), at 500. Each audio data group is then time synchronized to a time mark in the timeline of the audio sequence at 502. If the current word timeline is determined to be greater than a selected ADG timeline or the current ADG has a sound gap (at 504), the current audio data group is associated with a word number ‘0’ at 506. The zero word number indicates that the text should not be advanced. Otherwise, the current audio data group is associated with a current word number at 508.

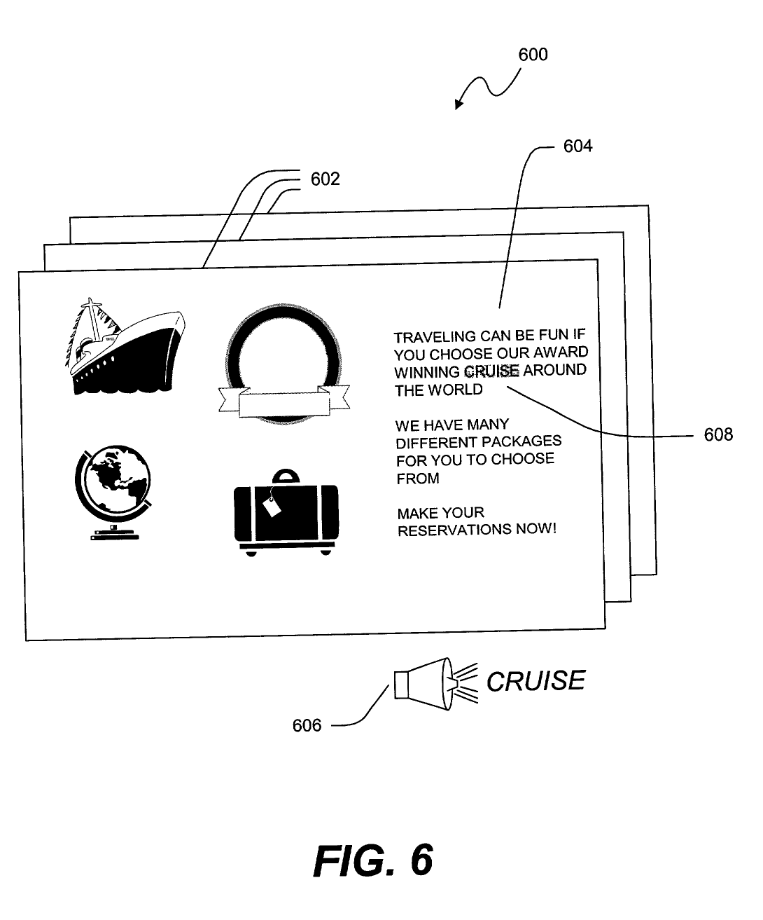

FIG. 6 shows one implementation of the multimedia synchronization system 600 in accordance with an embodiment of the present invention. In this embodiment, the multimedia system 600 has been implemented as a slide presentation system having a series of presentation slides 602. Moreover, the multimedia system 600 implements the synchronization process described above, in conjunction with the flowchart of FIG. 5. Each slide 602 includes a sequence of text data 604. The system 600 also includes a stream of audio data 606. The multimedia synchronization system 600 may receive and display the entire text content at the beginning of the slide. The system 600 highlights the text “cruise” 608 in the text data 604, at a time mark when the audio source 606 makes the sound “cruise”. At the next time mark when the audio source 606 makes the sound “around”, the text “around” is highlighted, and so on.

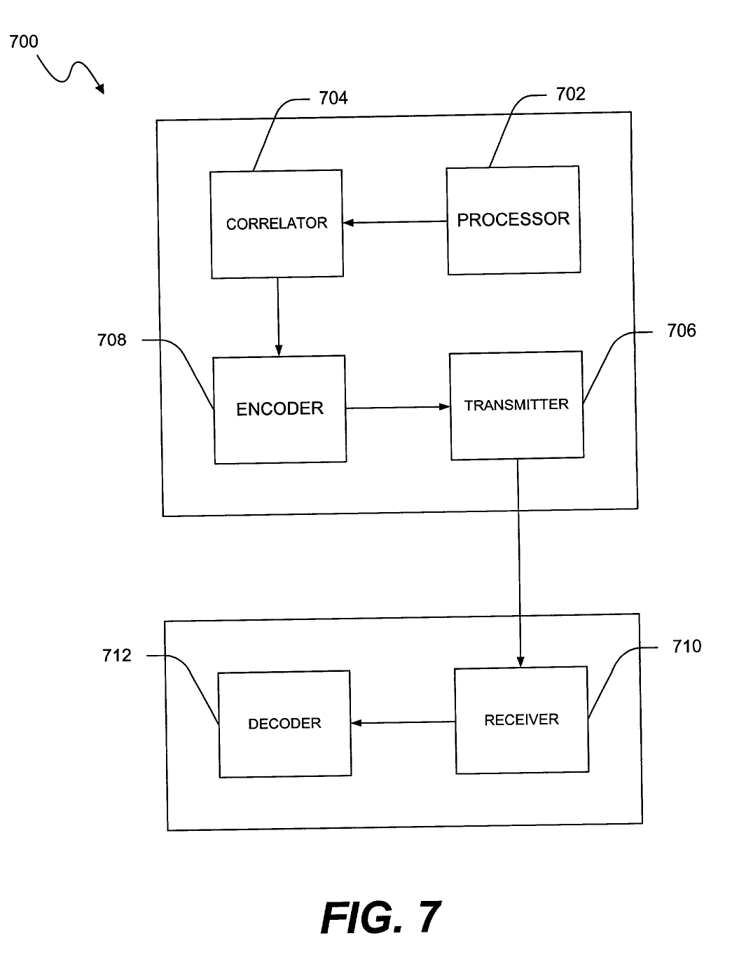

FIG. 7 shows a multimedia system 700 according to an embodiment of the present invention. The system 700 includes a processor 702, a correlator 704, an encoder 706, a transmitter 708, a receiver 710, and a decoder 712.

The processor 702 divides audio data into at least one audio data group and synchronizes a current audio data group to a nearest time mark. The correlator 704 associates the current audio data group to a number of a word in text data corresponding to the current audio data group. The encoder 706 packs the plurality of audio data groups along with associated word numbers into a plurality of data packets. The transmitter 708 transmits and receiver 710 receives the plurality of data packets. The decoder 712 unpacks the plurality of audio data groups along with associated word numbers, and provides the plurality of audio data groups to a processor in the destination node. The decoder 712 also arranges each of the plurality of audio data groups to be synchronized to a word in the text data.

There has been disclosed herein embodiments for a multimedia system that synchronizes multimedia data without using timestamps. In one embodiment, the present system includes a slide presentation system having a series of presentation slides, an audio sequence, and a text sequence. Thus, the system is configured to synchronize audio data groups in the audio sequence with words in the text sequence. The synchronization may be achieved by dividing the audio sequence into audio data groups that are synchronized to time marks in the audio timeline. The words in the text sequence may then be synchronized to the audio data groups by linking the word number with each audio data group. A special word number (e.g. word number ‘0’) may be used to indicate that the text should not be advanced when the size of the word is larger than the selected ADG size or when the current audio data group has a gap in the sound.

While specific embodiments of the invention have been illustrated and described, such descriptions have been for purposes of illustration only and not by way of limitation. Accordingly, throughout this detailed description, for the purposes of explanation, numerous specific details were set forth in order to provide a thorough understanding of the present invention. It will be apparent, however, to one skilled in the art that the system and method may be practiced without some of these specific details. For example, although the embodiments have been described for audio-text synchronization in a slide presentation system, the present invention may be applicable to other multimedia system. Thus, the audio-text synchronization of the present invention may be used in an audio-visual system to synchronize the audio with words in the text. Further, packets may be configured to be longer than the 200-millisecond size illustrated in the above embodiments. Hence, one data packet may include more than two audio data groups. In other instances, well-known structures and functions were not described in elaborate detail in order to avoid obscuring the subject matter of the present invention. Accordingly, the scope and spirit of the invention should be judged in terms of the claims which follow.

What is claimed is:

1. A method for synchronizing multimedia data having at least audio and text sequences, comprising:
dividing the audio sequence into at least one audio data group;
synchronizing a current audio data group of said at least one audio data group to a nearest time mark; and
associating said current audio data group to a number of a word in the text sequence corresponding to said current audio data group.

2. The method of claim 1, wherein size of each of said at least one audio data group is a multiple of audio frame size.

3. The method of claim 1, wherein an interval of the time mark is substantially similar in size as that of each of said at least one audio data group.

4. The method of claim 3, wherein said associating said current audio data group includes associating said group to a number not used by any word in the text sequence when word size is larger than the size of each of said at least one audio data group or when the current audio data group has a gap in the text sequence.

5. The method of claim 4, wherein said number includes zero.

6. The method of claim 1, wherein the size of each of said at least one audio data group is 100 milliseconds.

7. A method for synchronizing a text sequence with an audio sequence, comprising:
arranging the audio sequence into a plurality of audio data groups;
synchronizing a current audio data group of said at least one audio data group to a nearest time mark;
associating said current audio data group to a number of a word in the text sequence corresponding to said current audio data group; and
packetizing said plurality of audio data groups along with associated word numbers.

8. The method of claim 7, wherein said packetizing includes sequentially packing said plurality of audio data groups and said associated word numbers into at least one packet.

9. The method of claim 8, wherein a first packet of said at least one packet also includes the text sequence.

10. A computer readable medium containing executable instructions which, when executed in a processing system, causes the system to perform multimedia data synchronization, comprising:
dividing the audio sequence into at least one audio data group;
synchronizing a current audio data group of said at least one audio data group to a nearest time mark; and
associating said current audio data group to a number of a word in the text sequence corresponding to said current audio data group.

11. The computer readable medium of claim 10, further comprising:
packetizing said plurality of audio data groups along with associated word numbers.

12. A multimedia data synchronization system, comprising:
means for dividing audio data into at least one audio data group;
means for synchronizing a current audio data group of said at least one audio data group to a nearest time mark; and
means for associating said current audio data group to a number of a word in text data corresponding to said current audio data group.

13. The system of claim 12, further comprising:
means for packetizing said plurality of audio data groups along with associated word numbers.

14. A multimedia system, comprising:
a processor to divide audio data into at least one audio data group, said processor configured to synchronize a current audio data group of said at least one audio data group to a nearest time mark; and
a correlator to associate said current audio data group to a number of a word in text data corresponding to said current audio data group.

15. The system of claim 14, further comprising:
an encoder to pack said plurality of audio data groups along with associated word numbers into a plurality of data packets.

16. The system of claim 15, wherein a first packet of said plurality of data packets includes the text data.

17. The system of claim 15, further comprising:
a transmitter to transmit said plurality of data packets to a destination node; and
a receiver to receive said plurality of data packets from a source node.

18. The system of claim 17, further comprising:
a decoder to unpack said plurality of audio data groups along with associated word numbers, said decoder providing said plurality of audio data groups to a processor in the destination node, such that said decoder arranges each of said plurality of audio data groups to be synchronized to a word in the text data.
